(19) United States
(12) Patent Application Publication
(10) Pub. No.: US 2026/0017622 A1
(43) Pub. Date: Jan. 15, 2026

(54) METHOD AND SYSTEM FOR MANAGING MULTI-USE OR DISPOSABLE CONTAINERS THROUGH CONTAINER UNIQUE IDENTIFIER SYSTEM

(71) Applicant: OYSTER ABLE CO., LTD., Seoul (KR)

(72) Inventors: Tae Goan BAE, Seoul (KR); Eric MICHEL GONZALEZ, Seoul (KR)

(21) Appl. No.: 18/992,553

(22) PCT Filed: Apr. 18, 2023
(86) PCT No.: PCT/KR2023/005194

§ 371 Date: Feb. 5, 2025

(30) Foreign Application Priority Data
Jul. 8, 2022 (KR) 10-2022-0084229

(51) Int. Cl. G06Q 10/30; B65D 25/20; G06K 19/06

(52) U.S. Cl. CPC G06Q 10/30; B65D 25/205; G06K 19/06037

(57) ABSTRACT

Provided are a method and system for managing multi-use or disposable containers. The method, performed by a computing device, for managing multi-use or disposable containers according to the present invention comprises the steps of: generating and providing a CUID; receiving recovery information, including the CUID, from a container recovery apparatus when a multi-use or disposable container including the CUID is recovered into the container recovery apparatus; calling a collection company that is to collect the multi-use or disposable container, loaded in the container recovery apparatus, on the basis of the recovery information; and updating a recycling history of the multi-use or disposable container collected through the collection company, the recycling history being updated on the basis of the result of a product inspection of the multi-use or disposable container.

### TECHNICAL FIELD

The present invention relates to a method and system for managing reusable or disposable containers. More specifically, the present invention relates to a method and system for managing reusable or disposable containers provided by a food store such as a beverage store or the like.

### BACKGROUND ART

As social interest in the environment increases recently, various regulations for reducing use of disposable containers are proposed. In addition, people are gradually joining the social movement of refraining from using disposable containers in a way of using personal tumblers when visiting a coffee shop or the like.

However, most restaurants and coffee shops still use disposable containers when packaging food, and although the stores desire to use reusable or disposable containers, there is a problem in that the recovery rate of the reusable or disposable containers is low since a system for recovering the reusable or disposable containers is not established properly. In addition, when the reusable or disposable containers are not properly collected and thrown away, there is also a problem of generating environmental pollution.

Although there are events that provide a discount as a reward for using personal reusable or disposable containers such as tumblers or the like or provide reusable or disposable containers as a prize, use of the reusable or disposable containers has not been yet widespread for the various reasons as described above.

Particularly, from the perspective of business, it is difficult to invest manpower and cost in the collection process, defect detection process, and washing process provide and recover reusable or disposable containers, and from the perspective of general users, there is a problem in that users feel the process of recovering the reusable or disposable containers troublesome or there is no special motivation for collecting reusable or disposable containers.

### DISCLOSURE OF INVENTION

### Technical Problem

Therefore, the present invention has been made in view of the above problems, and it is an object of the present invention to provide a method and system for managing reusable or disposable containers, which can systematically create a database of recovery and recycling history of the reusable or disposable containers by using unique identifiers of the reusable or disposable containers.

Another object of the present invention is to provide a method and system for managing reusable or disposable containers, which can operate the steps of distributing, recovering, loading, sending, washing, and recycling reusable or disposable containers to be interconnected with each other.

Another object of the present invention is to provide a method and system for managing reusable or disposable containers, which can encourage consumers to return reusable or disposable containers more actively by providing a deposit or a reward to the consumers who return the reusable or disposable containers.

The technical problems of the present invention are not limited to the technical problems mentioned above, and unmentioned other technical problems will be clearly understood by those skilled in the art from the following descriptions.

### Technical Solution

To accomplish the above objects, according to one aspect of the present invention, there is provided a method of managing reusable or disposable containers, the method performed by a computing device and comprising the steps of: generating and providing a CUID; receiving recovery information including the CUID from a container recovery apparatus when a reusable or disposable container including the CUID is recovered in the container recovery apparatus; calling a collection company that will collect reusable or disposable containers loaded in the container recovery apparatus on the basis of the recovery information; and updating recycling history of the reusable or disposable container on the basis of a result of product inspection on the reusable or disposable container collected through the collection company.

As an embodiment, the method of managing reusable or disposable containers may further comprise the step of receiving stock information including the CUID from a store terminal when the reusable or disposable container including the CUID is stocked in the store.

As an embodiment, the step of receiving stock information including the CUID may include the step of updating the recycling history of the reusable or disposable container on the basis of the stock information.

As an embodiment, the step of receiving recovery information including the CUID may include the steps of: calculating a recovery reward corresponding to the reusable or disposable container on the basis of the CUID; and transmitting reward information to the container recovery apparatus on the basis of the calculated recovery reward.

As an embodiment, the reward information may include the recovery reward and a reward accumulation means for accumulating the recovery reward.

As an embodiment, the recovery reward may be calculated differently according to the reward accumulation means.

As an embodiment, the step of receiving container recovery information including the CUID may further include the step of paying the recovery reward according to the reward accumulation means selected by a user.

As an embodiment, the step of receiving recovery information including the CUID may further include the step of updating the recycling history of the reusable or disposable container on the basis of the recovery information.

As an embodiment, the step of calling a collection company may include the steps of: determining a container loading state of the container recovery apparatus on the basis of the recovery information; and calling a collection company to collect reusable or disposable containers loaded in the container recovery apparatus when the container loading state satisfies a first condition.

As an embodiment, the collection company may be determined on the basis of a priority calculated according to a distance between the container recovery apparatus and the collection company and a service fee of the collection company.

As an embodiment, the priority may be determined on the basis of a calculation formula that calculates a weighted sum of the distance and the service fee, wherein in the calculation formula, a first weight applied to the distance or a second weight applied to the service fee may be determined differently when the container loading state is the first condition and a second condition.

As an embodiment, the step of calling a collection company may further include the step of granting a right to access the container recovery apparatus to the collection company.

As an embodiment, the recovery information may include identification information of a container box provided in the container recovery apparatus, and the CUID of the reusable or disposable container may be mapped to the identification information of the container box.

As an embodiment, the recycling history of the reusable or disposable container may be updated in connection with the management history of the container box.

According to another aspect of the present invention, there is provided a system for managing reusable or disposable containers, the system comprising: a processor; a memory that loads a computer program executed by the processor; and a storage for storing the computer program, wherein the computer program includes instructions for executing an operation of generating and providing a CUID, an operation of receiving recovery information including the CUID from a container recovery apparatus when a reusable or disposable container including the CUID is recovered in the container recovery apparatus, an operation of calling a collection company that will collect reusable or disposable containers loaded in the container recovery apparatus on the basis of the container recovery information, and an operation of updating recycling history of the reusable or disposable container on the basis of a result of product inspection on the reusable or disposable container collected through the collection company.

### Advantageous Effects

According to the embodiments of the present invention described above, recovery and recycling history of the reusable or disposable containers may be systematically created as a database using unique identifiers of the reusable or disposable containers.

In addition, since the steps of distributing, recovering, loading, sending, washing, and recycling reusable or disposable containers may be operated to be interconnected with each other, recycling history of the reusable or disposable containers can be managed effectively.

In addition, since a deposit or a reward is provided to consumers who return reusable or disposable containers, and a solution that allows users to utilize the deposit or reward most conveniently is provided, recovery of the reusable or disposable containers can be encouraged more actively.

### BRIEF DESCRIPTION OF THE DRAWINGS

FIG. 1 is a view schematically showing a reusable or disposable container management system according to an embodiment of the present invention.

FIG. 2 is a flowchart illustrating a method of managing a reusable or disposable container according to an embodiment of the present invention.

FIG. 3 is a view for further explaining exemplary forms of CUIDs imprinted on a container.

FIG. 4 is an exemplary view for further explaining recycling history of a reusable or disposable container.

FIG. 5 is an exemplary view showing a method of providing recycling history of a reusable or disposable container through a mobile application or a user terminal screen.

FIG. 6 is a flowchart illustrating an embodiment that further specifies step S300 of FIG. 2.

FIG. 7 is a view for further explaining step S330 of FIG. 6.

FIG. 8 is a flowchart illustrating an embodiment that further specifies step S400 of FIG. 2.

FIG. 9 is a view for further explaining a method of determining a collection company that will collect reusable or disposable containers.

FIG. 10 is a view showing a specific embodiment of collectively updating recycling history of reusable or disposable containers in connection with a container box identification number.

FIG. 11 is a block diagram showing an exemplary hardware configuration of a computing device in which various embodiments of the present invention are implemented.

FIG. 12 is a view for further explaining the reusable or disposable container management system of the present invention from the viewpoint of utilizing a CUID.

FIG. 13 is a view for further explaining main components of the entire system for managing a CUID.

FIG. 14 is a view for exemplarily explaining the detailed configuration of the computing server of FIG. 12.

FIG. 15 is a view for explaining an exemplary form of attaching a CUID to various types of containers.

### BEST MODE FOR CARRYING OUT THE INVENTION

Hereinafter, embodiments of the present invention will be described in detail with reference to the accompanying drawings. The advantages and features of the present invention and a method for achieving them will become clear with reference to the embodiments described below in detail, together with the accompanying drawings. However, the technical spirit of the present invention is not limited to the embodiments described below, and may be implemented in various different forms, and the following embodiments are provided only to complete the technical spirit of the present invention and fully inform those skilled in the art of the scope of the present invention, and the technical spirit of the present invention is defined only by the scope of the claims.

When adding reference symbols to components in each drawing, it should be noted that like symbols are given to like components as much as possible although the components are shown in different drawings. In addition, when it is determined in describing the present invention that a specific description of a related known configuration or function may obscure the gist of the present invention, detailed description thereof will be omitted.

Unless defined otherwise, all terms (including technical and scientific terms) used in this specification may be used in a meaning that can be commonly understood by those skilled in the art. In addition, terms defined in commonly used dictionaries are not to be ideally or excessively interpreted unless explicitly and specifically defined. The terms used in this specification are for the purpose of describing the embodiments and are not intended to limit the present invention. In this specification, singular forms also include plural forms unless specifically stated in the phrase.

In addition, in describing the components of the present invention, terms such as first, second, A, B, (a), (b), and the like may be used. These terms are intended only to distinguish the components from other components, and the nature, order, sequence, or the like of the components are not limited by the terms. When it is described that a component is “connected,” “coupled,” or “combined” with another component, it should be understood that although the component may be directly connected or combined with another component, other components may also be “connected,” “coupled,” or “combined” between the components.

The present invention describes a system and method for managing reusable or disposable containers through a CUID system to guarantee proper management, handling, reuse, or recycling of each container in the most effective manner.

A Container Unique Identifier (CUID) is an encrypted unique character set used to provide an exclusive and non-repeating code to a reusable or disposable container (e.g., box, cup, plate, etc.). The CUID may be used for any container and may be attached, adhered, printed, or imprinted on any material (e.g., cardboard box, plastic, paper, etc.).

Hereinafter, some embodiments of the present invention will be described in detail with reference to the accompanying drawings.

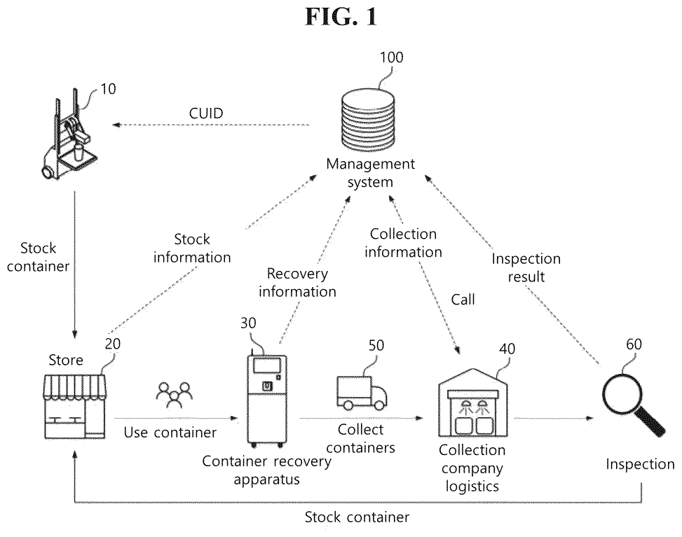

FIG. 1 is a view schematically showing a reusable or disposable container management system according to an embodiment of the present invention. Referring to FIG. 1, the overall system for managing reusable or disposable containers may include a CUID imprinting device 10, a store 20, a container recovery apparatus 30, a collection company 40, and/or a management system 100.

The management system 100 generates a Container Unique Identifier (CUID) to be assigned to a reusable or disposable container, and encodes and provides the CUID to the CUID imprinting device 10.

The CUID imprinting device 10 imprints the provided CUID on a reusable or disposable container. The reusable or disposable container with the CUID imprinted thereon is delivered and stocked in the store 20.

When a reusable or disposable container is stocked, the store 20 transmits stock information thereof to the management system 100 through a store terminal. The stock information may include the CUID of the reusable or disposable container. The management system 100 may update recycling history of the reusable or disposable container as being stocked in the store 20 on the basis of the stock information.

The reusable or disposable container stocked in the store 20 may be returned to the container recovery apparatus 30 after the container is used by a user.

The container recovery apparatus 30 is a device that recovers reusable or disposable containers provided by the store 20 after the containers are used. For example, when a user purchases food contained in a reusable container at the store 20, the reusable container is recovered in a way of returning the used reusable container to the container recovery apparatus 30 after the user eats all the food. The container recovery apparatus 30 may be a common device such as a kiosk or a stationary display device installed at a specific location.

When a reusable or disposable container is recovered, the container recovery apparatus 30 transmits recovery information thereof to the management system 100. The recovery information may include the CUID of the reusable or disposable container. The management system 100 may update the recycling history of the reusable or disposable container as being recovered to the container recovery apparatus 30 on the basis of the recovery information.

As an example, the recovery information may include loading information of the reusable or disposable container recovered in the container recovery apparatus 30. At this point, when the number of reusable or disposable containers loaded in the container recovery apparatus 30 is larger than a predetermined number, the management system 100 may call the collection company 40 to collect the reusable or disposable containers loaded in the container recovery apparatus 30 with reference to the loading information.

The collection company 40 may collect (50) the containers from the container recovery apparatus 30 in response to the call from the management system 100, and transmit information on the collected containers to the management system 100. In addition, the collection company 40 may wash and inspect the collected reusable or disposable containers (60), and stock reusable or disposable containers confirmed as being in good quality in the store 20 after the inspection. At this point, the inspection result of the reusable or disposable containers is transmitted to the management system 100, and the management system 100 may update the recycling history of the reusable or disposable container as being collected and inspected on the basis of the inspection result.

According to the reusable or disposable container management system of FIG. 1 described above, as the history is tracked and managed after a unique CUID is assigned to each reusable or disposable container on the basis of the CUID in the steps of stocking the reusable or disposable containers in the store, returning the reusable or disposable containers, collecting the reusable or disposable containers, inspecting the reusable or disposable containers, and/or restocking the reusable or disposable containers in the store, a database of recovery and recycling history of the reusable or disposable containers can be created systematically.

In addition, since the steps of distributing, collecting, loading, sending, washing, and recycling reusable or disposable containers may be operated to be interconnected with each other on the basis of the CUID, distribution, collection, and recycling of the reusable or disposable containers can be automated easily.

Meanwhile, as an embodiment, the management system 100 according to an embodiment of the present invention may be connected to the CUID imprinting device 10, the store 20, the container recovery apparatus 30, and/or the collection company 40 through a wired/wireless network for the sake of management and transmission/reception of information, and perform communication with each other.

At this point, each of the networks may be implemented in any type of wired/wireless networks, such as a Local Area Network (LAN), a Wide Area Network (WAN), a Value-Added Network (VAN), a Personal Area Network (PAN), a mobile radiocommunication network, a satellite communication network, and the like.

Hereinafter, the specific operation of the management system 100 based on the system of FIG. 1 and a management method thereof will be described in detail with reference to each drawing.

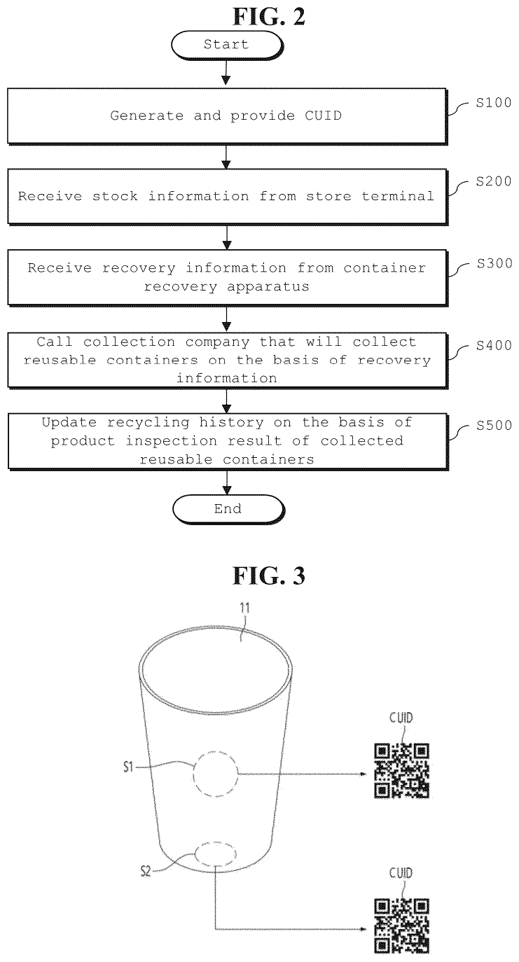

FIG. 2 is a flowchart illustrating a method of managing a reusable or disposable container according to an embodiment of the present invention. The method of managing a reusable or disposable container shown in FIG. 2 may be performed by the management system 100 shown in FIG. 1. Therefore, when a subject performing the operations is omitted in the following steps, it is assumed that the performing subject is the management system 100.

At step S100, a CUID to be assigned to a reusable or disposable container is generated and provided. The CUID is an identifier for distinguishing each reusable or disposable container, and may be configured of a combination of numbers, symbols, letters, figures, and/or other marks. The CUID may be converted into a separate code through encoding. The code may be a barcode, a QR code, and/or other computer-readable code.

The CUID is provided to the CUID imprinting device in the form of the code, and the CUID imprinting device may include the provided CUID on any one side of the reusable or disposable container. Here, the meaning of the ‘include’ includes that the CUID is imprinted, printed, attached, or embedded on any one side of the reusable or disposable container. The reusable or disposable container including the CUID is stocked in a store that has ordered reusable or disposable containers.

At step S200, when the reusable or disposable container including a CUID is stocked in the store, stock information of the reusable or disposable container is received from a store terminal.

As an embodiment, the stock information may include the CUID of the reusable or disposable container stocked in the store, the name of the store, the location of the store, the time of stocking the reusable or disposable container, and/or the state of the reusable or disposable container.

When the stock information is received, the recycling history of the reusable or disposable container may be updated on the basis of the stock information. Specifically, when the CUID of the reusable or disposable container is decoded after being extracted from the stock information, an information item of the reusable or disposable container is searched from the recycling history database on the basis of the decoded CUID, and the history is updated as being stocked in the store.

At step S300, when the reusable or disposable container stocked in the store is returned to the container recovery apparatus after being used, recovery information including the CUID is received from the container recovery apparatus.

As an embodiment, the recovery information may include the CUID of the reusable or disposable container recovered in the container recovery apparatus, the name of the container recovery apparatus, the location of the container recovery apparatus, the time of recovering the reusable or disposable container, and/or the state of the reusable or disposable container.

When the recovery information is received, the recycling history of the reusable or disposable container may be updated again on the basis of the recovery information. Specifically, when the CUID of the reusable or disposable container is decoded after being extracted from the recovery information, an information item of the reusable or disposable container is searched from the recycling history database on the basis of the decoded CUID, and the history is updated as being recovered in the container recovery apparatus.

At step S300, a collection company that will collect the reusable or disposable containers loaded in the container recovery apparatus may be called on the basis of the recovery information. As described above, the recovery information may include loading information of reusable or disposable containers in the container recovery apparatus. At this point, when it is determined that the number of reusable or disposable containers loaded in the container recovery apparatus is larger than a predetermined number with reference to the recovery information, a collection company may be called to collect the loaded reusable or disposable containers.

The called collection company approaches the container recovery apparatus and collects the reusable or disposable containers. At this point, the collection company may transmit collection information of the reusable or disposable containers to the management system through a collection company terminal.

As an embodiment, the collection information may include CUIDs of the reusable or disposable containers collected by the collection company, the name of the collection company, the location of the collection company, the time of collecting the reusable or disposable containers, and/or the state of the reusable or disposable containers.

When the collection information is received, the recycling history of the reusable or disposable containers may be updated again on the basis of the collection information. Specifically, the CUID of the reusable or disposable container is decoded after being extracted from the collection information, an information item of the reusable or disposable container is searched from the recycling history database on the basis of the decoded CUID, and the history is updated as being collected by the collection company.

The collected reusable or disposable containers are provided to a product inspection step for recycling after a washing step. At the product inspection step, it is determined whether the reusable or disposable containers are in a good state as to be recycled or in a bad state as not to be recycled. When the reusable or disposable containers is in a good state, the reusable or disposable containers are restocked in the store after a separate preparation step. On the other hand, when the reusable or disposable containers are in a bad state, the reusable or disposable containers are discarded.

Product inspection results of the reusable or disposable containers may be transmitted to the management system.

At step S500, the recycling history of the reusable or disposable containers is updated on the basis of the product inspection results of the reusable or disposable containers.

As an embodiment, the inspection results may include the CUID of the reusable or disposable container on which the inspection is completed, the name of the product inspection company, the location of the product inspection company, the time of completing the product inspection on the reusable or disposable container, the inspection result of the reusable or disposable container, and/or the disposal state of the reusable or disposable container on the basis of the inspection result.

When an inspection result is received, the recycling history of the reusable or disposable container may be updated again on the basis of the inspection result. Specifically, the CUID of the reusable or disposable container is decoded after being extracted from the inspection result, an information item of the reusable or disposable container is searched from the recycling history database on the basis of the decoded CUID, product inspection thereon is completed, and the history is updated as disposal of the reusable or disposable container is determined according to the result.

FIG. 3 is a view for further explaining exemplary forms of CUIDs imprinted on a container. A CUID is a unique identifier assigned to a reusable or disposable container 11, and may be in the form of a QR code as shown in FIG. 3, but it is not limited thereto. For example, the CUID may be in the form of a barcode, a figure, a picture, a symbol, or a combination thereof.

The CUID may be imprinted on one side of the reusable or disposable container 11. For example, the CUID may be imprinted on the side surface S1 of the reusable or disposable container, on the bottom S2 of the reusable or disposable container, or on both the side surface S1 and the bottom S2 of the reusable or disposable container.

Meanwhile, although an expression that the CUID is imprinted is used herein, this does not necessarily mean that it is imprinted on the surface of the reusable or disposable container 11 in an embossed or imprinted form. The meaning of imprinting herein may include printing the CUID on the surface of the reusable or disposable container 11 or embedding the CUID inside the reusable or disposable container 11.

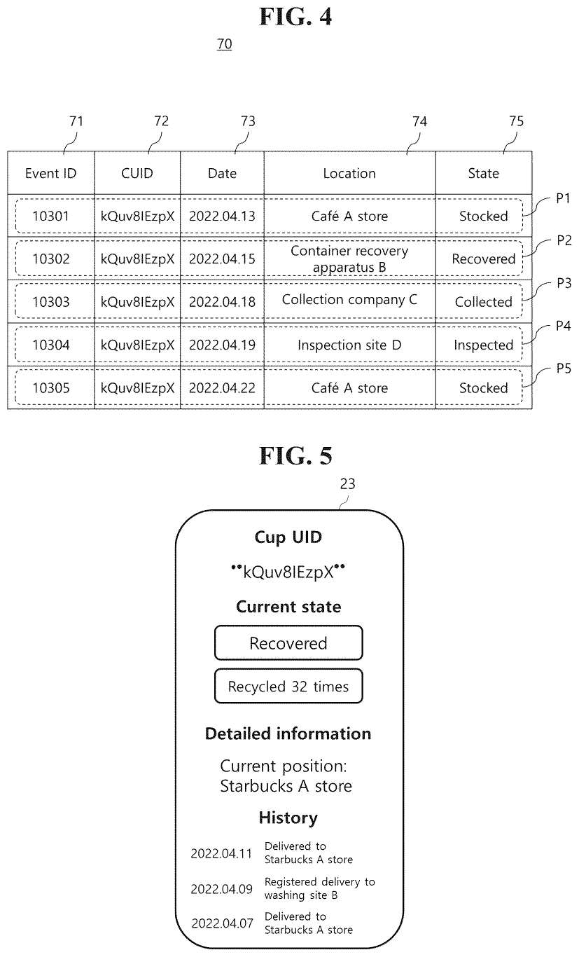

FIG. 4 is an exemplary view for further explaining recycling history of a reusable or disposable container. In FIGS. 1 and 2, it is described that the recycling history of a reusable or disposable container can be updated on the basis of the stock information, recovery information, collection information, and/or inspection results of the reusable or disposable container. FIG. 4 shows an exemplary form of the recycling history updated by the management system 100. Referring to FIG. 4, recycling history 70 of a reusable or disposable container may have a plurality of fields including an event ID 71, a CUID 72, a date 73, a location 74, and a state 75.

The event ID 71 indicates an identification number of an event that occurs in relation to a reusable or disposable container. The CUID 72 indicates a CUID assigned to the reusable or disposable container. The date 73 and the location 74 indicate the time and location at which the event has occurred, respectively. The state 75 indicates the current state of the reusable or disposable container according to occurrence of the event.

About this, the recycling history shown in FIG. 4 is described using a specific example.

It is assumed that a reusable or disposable container with a CUID of ‘kQuv8IEzpX’ is stocked in the store of cafe A, recovered in container recovery apparatus B, collected by collection company C, inspected at inspection site D, determined as being in good quality, and restocked in the store of cafe A.

At this point, when a reusable or disposable container is stocked in the store of Cafe A, the management system 100 receives stock information from a terminal in the store of Cafe A and updates a first item P1 of the recycling history 70 on the basis of the stock information. Information with an event ID of 10301, indicating that a reusable or disposable container with a CUID of ‘kQuv8IEzpX’ is stocked in the store of Cafe A on Apr. 13, 2022, is recorded in the first item P1.

Next, when the reusable or disposable container is recovered in container recovery apparatus B, the management system 100 receives recovery information from container recovery apparatus B and updates a second item P2 of the recycling history 70 on the basis of the recovery information. Information with an event ID of 10302, indicating that a reusable or disposable container with a CUID of ‘kQuv8IEzpX’ is recovered in container recovery apparatus B on Apr. 15, 2022, is recorded in the second item P2.

In the same manner, when the reusable or disposable container is collected by collection company C, a third item P3 of the recycling history 70 is updated, and when product inspection on the reusable or disposable container is completed at inspection site D, a fourth item P4 of the recycling history 70 is updated. In addition, when the reusable or disposable container is determined as being in good quality as a result of the product inspection and restocked in the store of cafe A, a fifth item P5 of the recycling history 70 is updated. In this manner, the history of the entire cycle of recycling the reusable or disposable container is recorded in the recycling history 70.

Meanwhile, the recycling history 70 of the reusable or disposable container updated in this way may be provided through a mobile application or a screen 76 of a user terminal as shown in FIG. 5.

The recycling history of a reusable or disposable container provided through a mobile application or user terminal may include the CUID, current state, number of times of recycling, current location, and/or past recycling history of the reusable or disposable container (e.g., cup) as shown in FIG. 5.

FIG. 5 is an exemplary view showing a method of providing recycling history of a reusable or disposable container through a mobile application or a user terminal screen.

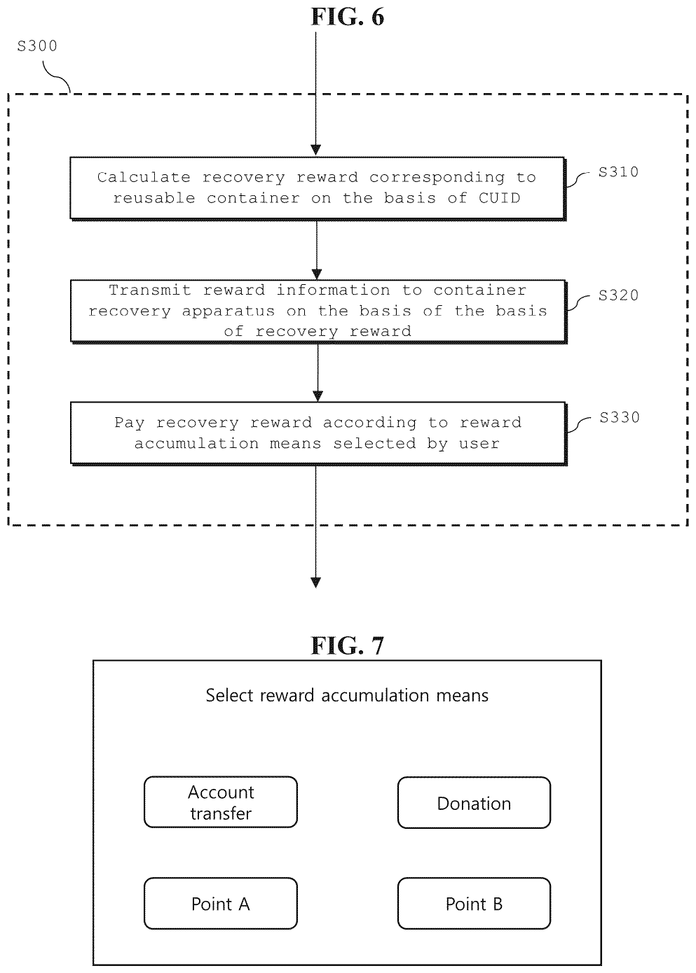

FIG. 6 is a flowchart illustrating an embodiment that further specifies step S300 of FIG. 2. In the embodiment of FIG. 6, an embodiment of calculating a recovery reward corresponding to the recovered container, when the management system receives recovery information from the container recovery apparatus, and paying the reward to the user who has returned the reusable or disposable container is described. This will be described in detail with reference to the drawings.

At step S310, a recovery reward corresponding to the reusable or disposable container is calculated on the basis of the CUID included in the recovery information. At this point, the calculated recovery reward may be calculated on the basis of the recognized CUID code imprinted on the reusable or disposable container recovered in the container recovery apparatus. For example, when the CUID is extracted from the recovery information, the management system may calculate a predetermined amount as a recovery reward corresponding to the CUID. For example, when the CUID of the reusable or disposable container is SSS101, 100 Korean Won (KRW) may be calculated, and when it is SSS102, 150 KRW may be calculated as a recovery reward for returning the reusable or disposable container.

As an embodiment, the management system may calculate the recovery reward differently according to the number of times of recycling the recovered reusable or disposable container. Since durability of the reusable or disposable container decreases as recycling of the reusable or disposable container is repeated, the residual value of the reusable or disposable container may decrease as the number of times of recycling the reusable or disposable container increases. Accordingly, the management system may calculate a smaller amount as the recovery reward as the number of times of recycling the reusable or disposable container increases in a method of calculating 150 KRW as the deposit or reward when the reusable or disposable container has been recycled 5 times and 100 KRW when the reusable or disposable container has been recycled 10 times.

At step S320, reward information is transmitted to the container recovery apparatus on the basis of the generated recovery reward.

As an embodiment, the reward information may include the recovery reward and a reward accumulation means for accumulating the recovery reward. At this point, the recovery reward may be calculated and determined differently according to the reward accumulation means.

For example, in the case where the recovery reward is calculated as 100 KRW on the basis of the CUID of the reusable or disposable container, the recovery reward will be reflected as 100 KRW when the reward accumulation means is account transfer, but when the reward accumulation means is point A, the recovery reward will be adjusted to 120 KRW as an affiliate premium is added. When the reward accumulation means is point B, a higher affiliate premium is added, and the recovery reward will be adjusted to 130 KRW. When the reward accumulation means is donation, a campaign for encouraging donation is applied, and the recovery reward may be adjusted to 150 KRW.

When the reward information is transmitted to the container recovery apparatus, the container recovery apparatus may display the reward information to the user and receive input of a reward accumulation means. For example, as shown in FIG. 7, the container recovery apparatus may display various reward accumulation means that the user may select through a display, and when the user selects one of the items, information on the accumulation means selected by the user may be returned to the management system.

At step S330, the recovery reward is paid according to the reward accumulation means selected by the user. When the example described above is used as is, the management system may pay the recovery reward in a method of transferring 100 KRW to an account specified by the user when the user selects account transfer, accumulating 120 KRW worth of A points for the user when the user selects point A, accumulating 130 KRW worth of B points for the user when the user selects point B, and donating 150 KRW to a donation organization specified by the user when the user selects donation.

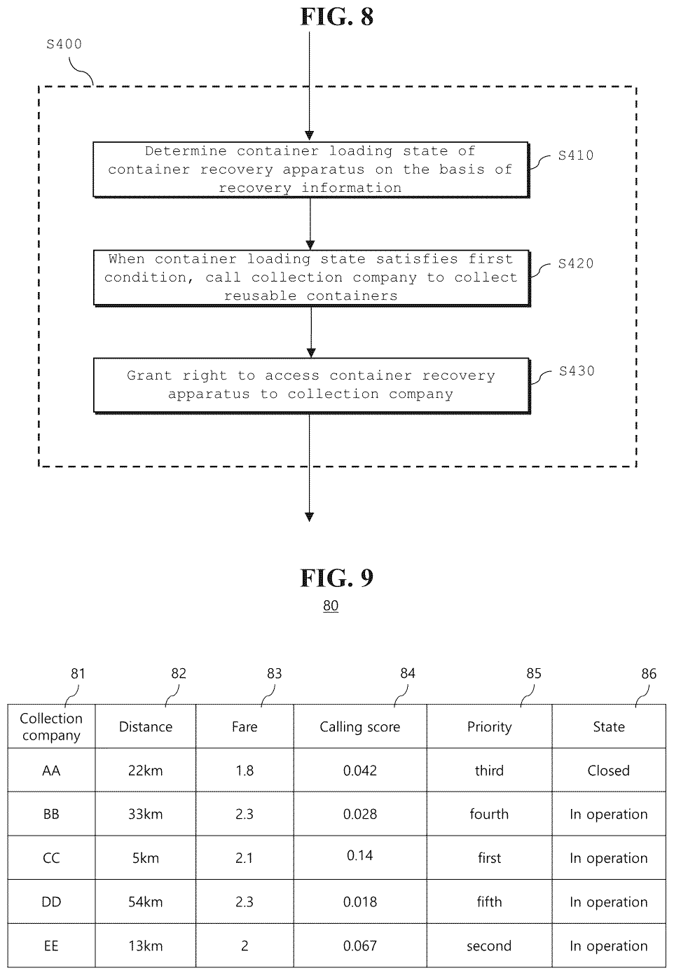

FIG. 8 is a view for further explaining step S400 of FIG. 6. In the embodiment of FIG. 8, an embodiment of calling, when the management system receives the recovery information from the container collection device, a collection company that will collect the reusable or disposable containers on the basis of the recovery information is described. This will be described in detail with reference to the drawing.

At step S410, the container loading state of the container recovery apparatus is determined on the basis of the recovery information. For example, the recovery information may include information indicating how many reusable or disposable containers are loaded in the container box of the container recovery apparatus, such as ‘50%’, ‘80%’, or ‘100%’. At this point, ‘50%’ may mean that 50% or more of the total loading capacity of the container box is loaded with reusable or disposable containers, ‘80%’ may mean that 80% or more of the total loading capacity of the container box is loaded with reusable or disposable containers, and ‘100%’ may mean that the total loading capacity of the container box is completely loaded with reusable or disposable containers.

At step S420, when the container loading state satisfies a first condition, a collection company is called to collect the reusable or disposable containers loaded in the container recovery apparatus. Here, the first condition is a condition preset to trigger collection of the reusable or disposable containers, for example, ‘container loading state of 80% or more’. In this case, the management system determines the container loading state of the container recovery apparatus on the basis of the recovery information, and when the container loading state is 80% or more, it is considered that the first condition is satisfied, and a collection company is called to collect the reusable or disposable containers.

As an embodiment, the collection company called by the management system may be determined on the basis of a priority calculated according to the distance between the container recovery apparatus 100 and the collection company and the service fee of the collection company. For example, the shorter the distance to the container recovery apparatus 100, the faster the containers may be collected, so that the shorter the distance, the higher the priority, and since the lower the service fee of the collection company, the lower the cost required for the collection, and thus the priority will be higher.

As an embodiment, the priority may be determined on the basis of a calculation formula that calculates a weighted sum of the distance between the container recovery apparatus and the collection company and the service fee of the collection company. At this point, the calculation formula is the mathematical formula shown below, and when a calling score is determined by the mathematical formula, the priority may be determined in a method of assigning a priority in order of higher calling scores.

Calling score=1/[(k1*P)+(k2*Q)] Mathematical formula:

Here, k1 is a predetermined first weight, k2 is a predetermined second weight, P is the distance between the container recovery apparatus and the collection company, and Q is the service fee of the collection company.

According to the mathematical formula, since the longer the distance between the container recovery apparatus and the collection company, and the higher the service fee of the collection company, the lower the calling score is calculated, and accordingly, a lower priority will be assigned.

An exemplary table that calculates calling scores and priorities according to the mathematical formulas is shown in FIG. 9. In the table 80 shown in FIG. 9, k1 and k2 are assumed to be 1, respectively.

Referring to the table 80 shown in FIG. 9, the table 80 may include fields such as collection company 81, distance 82, fare 83, calling score 84, priority 85, and state 86.

Among the fields, the collection company 81, the distance 82, and the fare 83 are values preset with reference to an internal or external database, the calling score 84 is a value calculated according to the distance and the fare on the basis of a predetermined calculation formula such as the mathematical formula, the priority 85 is a ranking value assigned in order of high calling scores, and the state 86 is a value indicating whether the collection company is in operation as of the current time.

The management system may determine and call a collection company of the highest priority on the basis of the values shown in Table 80 of FIG. 9 as a collection company that will collect the reusable or disposable containers.

As an embodiment, the management system may exclude collection companies that are not in operation currently from the companies to be called with reference to the state 86 field of the table 80. For example, in the case of the collection company AA, although the collection company is AA called, it will not be dispatched immediately to collect since the state 86 field is closed. In this way, when a company of which the state 86 field is closed is called, the company may not be dispatched immediately, and collection of reusable or disposable containers is delayed. Therefore, the management system may exclude collection companies that are not in operation currently from the companies to be called with reference to the state 86 field.

As an embodiment, in the above mathematical formula, the first weight or the second weight may vary according to the container loading state of the container recovery apparatus. For example, a case where the container loading state is ‘80%’ and a case where the container loading state is ‘100%’ are assumed.

In this case, when it is determined that the container loading state is ‘80%’, the management system determines that it is not a very urgent situation although collection of the reusable or disposable containers is needed, and may determine the calling score using normal values as the first and second weights (for example, k1=k2=1).

On the other hand, when it is determined that the container loading state is ‘100%’, the management system determines that collection of the reusable or disposable containers is very urgent, and may determine the calling score by increasing the first weight, which is the weight for the distance, from the normal value and decreasing the second weight, which is the weight for the service fee, from the normal value (for example, k1=2, k2=0.5).

According to the embodiment, in a situation where the container loading state is ‘100%’, as a collection company in a shorter distance is called first although the service fee is somewhat higher, the reusable or disposable containers loaded in the container recovery apparatus may be collected more quickly.

At step S430, a right to access the container recovery apparatus is granted to the collection company. In order for the collection company to collect reusable or disposable containers from the container recovery apparatus, an access right for opening the container recovery apparatus should be granted to the collection company. For this purpose, the management system may grant a right to access the container recovery apparatus to the collection company terminal in the form of a dynamic QR code or the like.

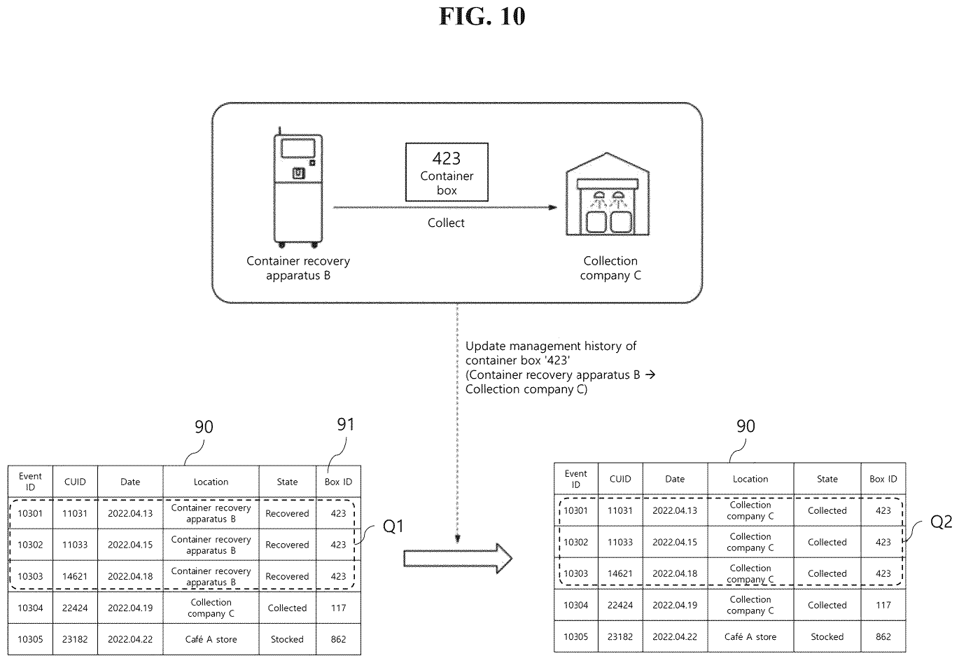

FIG. 10 is a view showing a specific embodiment of collectively updating recycling history of reusable or disposable containers in connection with a container box identification number. In the embodiment of FIG. 10, it is assumed that a container box having a container box ID of ‘423’ is included in container recovery apparatus B, and reusable or disposable containers having CUIDs of ‘11031’, ‘11033’, and ‘14621’ are recovered through container recovery apparatus B and loaded in container box ‘423’.

When reusable or disposable containers with CUIDs ‘11031’, ‘11033’, and ‘14621’ are recovered, container collection device B transmits recovery information thereof to the management system, and the management system updates recycling history of the reusable or disposable containers on the basis of the transmitted recovery information.

As an embodiment, the recovery information may include identification information of the container box provided in the container recovery apparatus, i.e., a container box ID. At this point, the CUID of a reusable or disposable container may be mapped to the identification information of the container box.

An example of updating the recycling history of a reusable or disposable container in this way is shown in the lower left portion of FIG. 10. The recycling history 90 in the lower left portion further includes a container box ID 91 field, and the CUID of each reusable or disposable container is mapped to the identification information of the container box, in which the reusable or disposable containers are loaded, through the container box ID 91 field. For example, referring to the recycling history 90 in the lower left portion, the CUIDs ‘11031’, ‘11033’, and ‘14621’ of the reusable or disposable containers are mapped to the container box ID ‘423’ (Q1).

Meanwhile, it is assumed that the container loading state of container recovery apparatus B satisfies a predetermined condition and the reusable or disposable containers are recovered by collection company C. In this case, collection company C may collect the reusable or disposable containers as they are loaded in the container box ‘423’, instead of taking out only the reusable or disposable containers from container box ‘423’. At this point, collection company C may transmit information indicating that container box ‘423’ is collected to the management system as collection information.

The management system updates the management history of the container box to ‘collected’ with reference to the collection information. At this point, the management system may collectively update the recycling history of the reusable or disposable containers mapped to the container box, in connection with update of the management history of the container box.

Referring to the lower right portion of FIG. 10, an example of collectively updating the recycling history of the reusable or disposable containers in connection with update of management history of the container box is shown.

For example, when it is assumed that the management history of container box ‘423’ is updated to ‘collected’, in connection with the update, the recycling history of the reusable or disposable containers mapped to container box ID ‘423’ in the table 90 in the lower right portion may also be collectively updated to ‘collected’ (Q2).

According to the various embodiments of the present invention described above, recovery and recycling history of the reusable or disposable containers may be systematically created as a database using unique identifiers of the reusable or disposable containers. In addition, since the steps of distributing, recovering, loading, sending, washing, and recycling reusable or disposable containers may be operated to be interconnected with each other, recycling history of the reusable or disposable containers can be managed effectively. In addition, since a deposit or a reward is provided to consumers who return reusable or disposable containers, and a solution that allows users to utilize the deposit or reward most conveniently is provided, recovery of the reusable or disposable containers can be encouraged more actively.

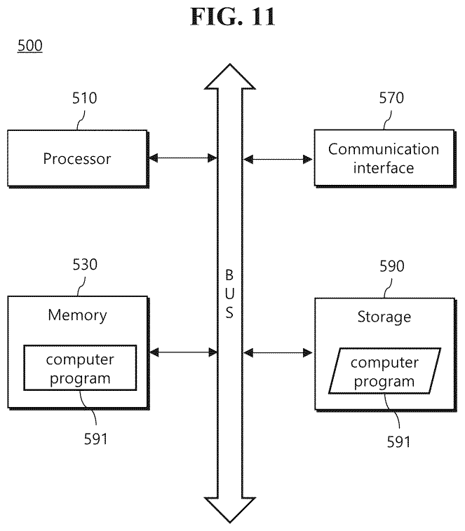

Hereinafter, an exemplary computing device 500 in which the methods described in various embodiments of the present invention are implemented will be described with reference to FIG. 11. For example, the computing device 500 of FIG. 11 may be the management system 100 shown in FIG. 1.

FIG. 11 is an exemplary hardware configuration diagram showing the computing device 500.

As shown in FIG. 11, the computing device 500 may include one or more processors 510, a bus 550, a communication interface 570, a memory 530 for loading a computer program 591 executed by the processor 510, and a storage 590 for storing the computer program 591. However, only the components related to the embodiment of the present invention are shown in FIG. 11. Therefore, those skilled in the art may know that other general components may be included, in addition to the components shown in FIG. 11.

The processor 510 controls the overall operation of each component of the computing device 500. The processor 510 may be configured to include at least one among a Central Processing Unit (CPU), a Micro Processor Unit (MPU), a Micro Controller Unit (MCU), a Graphics Processing Unit (GPU), and any other types of processors well known in the technical field of the present invention. In addition, the processor 510 may perform operation of at least one application or program for executing a method/operation according to various embodiments of the present invention. The computing device 500 may include one or more processors.

The memory 530 stores various data, commands, and/or information. The memory 530 may load one or more programs 591 from the storage 590 to execute the methods/operations according to various embodiments of the present invention. An example of the memory 530 may be RAM, but it is not limited thereto.

The bus 550 provides communication functions between the components of the computing device 500. The bus 550 may be implemented as various types of buses such as an address bus, a data bus, a control bus, and the like.

The communication interface 570 supports wired and wireless Internet communications of the computing device 500. The communication interface 570 may also support various communication methods in addition to Internet communications. To this end, the communication interface 570 may be configured to include a communication module well known in the technical field of the present invention.

The storage 590 may non-temporarily store one or more computer programs 591. The storage 590 may be configured to include volatile memory such as Read Only Memory (ROM), Erasable Programmable ROM (EPROM), Electrically Erasable Programmable ROM (EEPROM), flash memory, a hard disk, a removable disk, or any form of computer-readable recording medium well known in the technical field of the present invention.

The computer program 591 may include one or more instructions implementing the methods/operations according to various embodiments of the present invention. For example, the computer program 591 may include instructions for performing an operation of generating and providing a CUID, an operation of receiving container recovery information including the CUID from the container recovery apparatus when a reusable or disposable container with a CUID attached thereto is recovered in the container recovery apparatus, an operation of calling a collection company that will collect reusable or disposable containers loaded in the container recovery apparatus on the basis of the container recovery information, and an operation of updating the recycling history of the reusable or disposable container on the basis of a result of product inspection on the reusable or disposable container collected through the collection company.

When the computer program 591 is loaded on the memory 530, the processor 510 may perform the methods/operations according to various embodiments of the present invention by executing the one or more instructions.

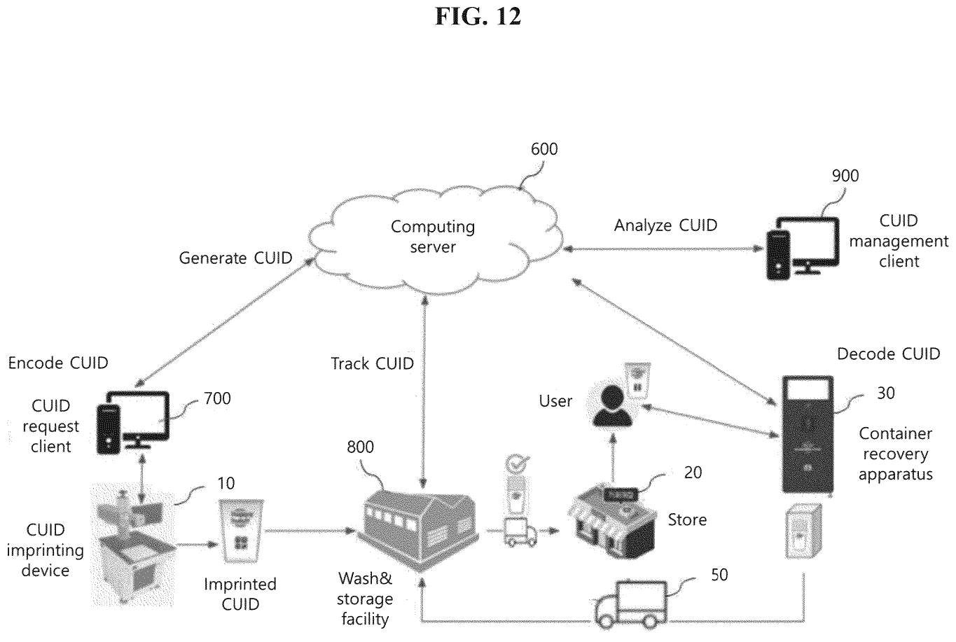

FIG. 12 is a view for further explaining the reusable or disposable container management system of the present invention from the viewpoint of utilizing a CUID. In FIG. 12, the computing server 600 may be a reusable or disposable container management system of the present invention.

When the computing server 600 generates a CUID, the generated CUID is transmitted to the CUID request client 700 for CUID encoding. The CUID request client 700 provides the received CUID to the imprinting device 10, and the imprinting device 10 imprints the CUID on the container.

The container with the imprinted CUID is provided to the wash and storage facility 800, and the wash and storage facility 800 communicates with the computing server 600 and transmits CUID information of the container, and the computing server 600 tracks the CUID.

Thereafter, the container with the imprinted CUID is transported to the store 20, and containers used by users are collected in the container recovery apparatus 30. CUID decoding is performed in the container recovery apparatus 30, and a result thereof is transmitted to the computing server 600.

Meanwhile, the CUID management client 900 communicates with the computing server 600 and performs CUID analysis.

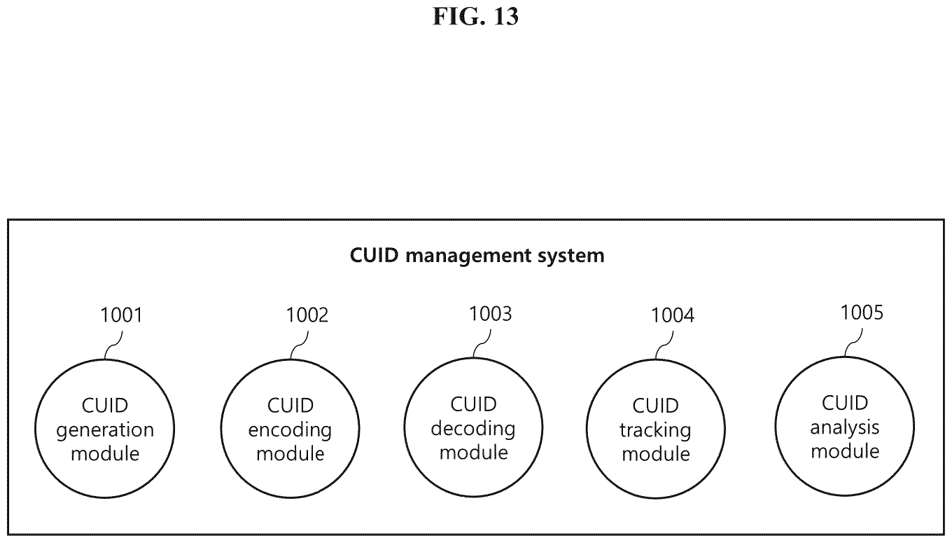

Details of the system shown in FIG. 12 will be further explained through the descriptions of FIGS. 13 to 15.

FIG. 13 is a view for further explaining main components of the entire system for managing a CUID. Referring to FIG. 13, the entire system for CUID management includes at least five modules such as a CUID generation module 1001, a CUID encoding module 1002, a CUID decoding module 1003, a CUID tracking module 1004, and a CUID analysis module 1005.

The CUID generation module 1001 may perform at least three steps of functions. At step 1, generation of an exclusive and non-repeating code is performed on the basis of the date and time of generating the CUID code and the device information (e.g., management system). At step 2, encryption of the code generated at step 1 is performed using a predetermined algorithm to form a CUID code. At step 3, the encrypted code generated at step 2 is stored, and all settings and attributes related to each CUID code are stored. In FIG. 12, the computing server 600 belongs to the CUID generation module 1001.

The CUID encoding module 1002 may be configured of a client device 700 requesting a CUID code from the API of the computing server 600, and an imprinting device 10 for setting the CUID on each reusable or disposable container.

The CUID decoding module 1003 may be configured of a decoding device, such as a QR code scanner, capable of reading and converting a CUID code into readable string data characters.

The CUID tracking module 1004 may include a wash and storage facility 800 that will transmit CUID data and information to the API of the computing server 600 to monitor the process and state of each CUID. The CUID tracking module 1004 may include at least one device such as a sensor, a scanner, and the like to facilitate the process of tracking and monitoring CUID code, and at least one computing device for communicating and transmitting CUID data from the tracking device to the API of the computing server 600.

The CUID analysis module 1005 may access all data reports related to the CUID management system 100 and include the CUID management client 900 for managing the CUID system.

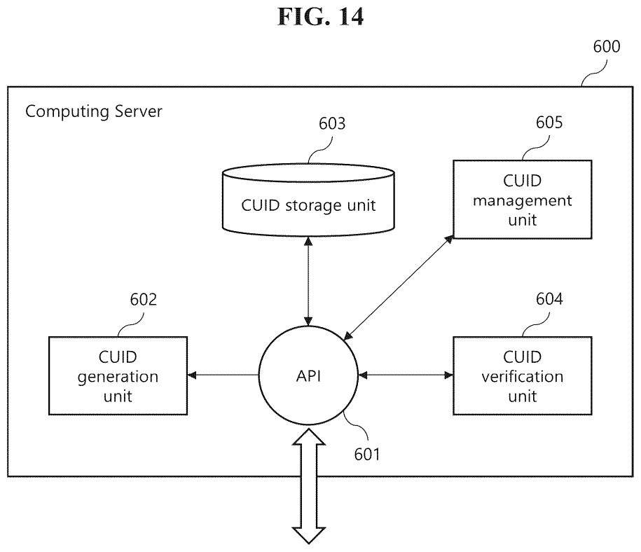

FIG. 14 is a view for exemplarily explaining the detailed configuration of the computing server of FIG. 12.

The computing server 600 may be in charge of all processes related to CUID generation, CUID tracking and monitoring, and CUID analysis and management.

The computing server 600 may include an application program interface (API) 601 characterized by a computer program capable of executing computer commands and computing algorithms, a CUID generation unit 602, a CUID storage unit 603, a CUID verification unit 604, and a CUID management unit 605.

The computing server 600 may also include a CUID generation unit 602 of a code script form in charge of processing steps 1 and 2 described above.

The computing server 600 may also include in itself a CUID storage unit 603 which may include an internal or external database (e.g., SQL, NoSQL, etc.) and a code script for storing all data related to the CUID system. The CUID storage module performs processes related to step 3 described above, and stores all data related to the CUID management system.

The computing server 600 may also include a CUID verification unit 604, and may include in itself a code script so that the CUID verification unit 604 may legalize and authenticate validity of inquiring each received CUID code.

The computing server 600 may also include a CUID management unit 605 of a code script form in charge of all inquiry services related to tracking, monitoring, and analyzing each CUID code.

In the above description, the CUID management system may include software components and hardware components described below.

First, the software components may include the configurations described below, such as a computing server API 601, an application 76 for end users, software for inquiring all CUIDs collected from the container recovery apparatus 30 and performing maintenance services for the CUID system by system maintenance staff, and a system management application executed in the CUID management client 900 to perform various tasks related to system management, monitoring, analysis, and CUID management system.

First, the hardware components may include the configurations described below.

It may include an encoding device 700 and an imprinting device 10, a wash and storage facility 800, a container recovery apparatus 30, a tracking device described in the CUID tracking module 1004, a container collection and transport company 50, a CUID management client 900, and the like.

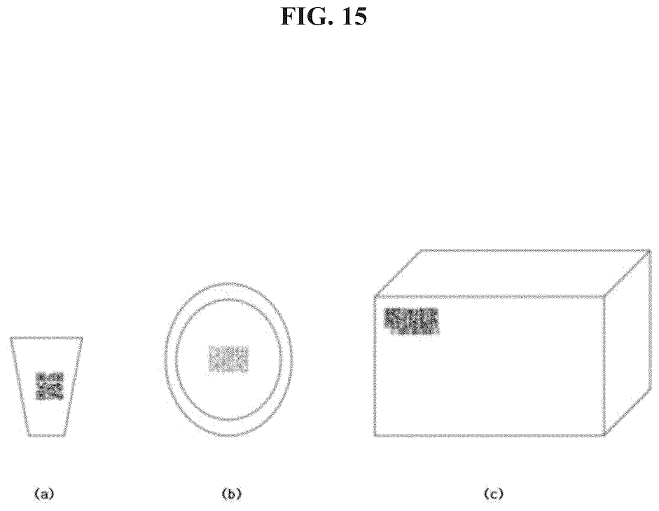

FIG. 15 is a view for explaining an exemplary form of attaching a CUID to various types of containers.

FIG. 15 shows an example of different CUID codes encoded and imprinted on different types of containers. FIG. 14(a) shows an example of an encoded QR code attached on a cup-type container, FIG. 14(b) shows an example of an engraved dot code attached on a plate-type container, and FIG. 14(c) shows an example of a CC-B code restrictively added to an engraved RSS for a container box-type container.

The technical spirit of the present invention described so far may be implemented as a computer-readable code on a computer-readable medium. The computer-readable recording medium may be, for example, a removable recording medium (CD, DVD, Blu-ray disc, USB storage device, removable hard disk) or a fixed recording medium (ROM, RAM, computer-attached hard disk). The computer program recorded on the computer-readable recording medium may be transmitted to another computing device through a network such as the Internet or the like to be installed in another computing device, and therefore, may be used in another computing device.

Although the embodiments of the present invention have been described with reference to the accompanying drawings, those skilled in the art will understand that the present invention may be implemented in other specific forms without changing the technical spirit or essential features thereof. Therefore, it should be understood that the embodiments described above are exemplary and not restrictive in all respects. The protection scope of the present invention should be interpreted by the following claims, and all technical spirits within the equivalent scope should be interpreted as being included in the scope of the technical spirit defined by the present invention.

1. A method of managing reusable or disposable containers, the method performed by a computing device and comprising the steps of:
generating and providing a CUID;
receiving recovery information including the CUID from a container recovery apparatus when a reusable or disposable container including the CUID is recovered in the container recovery apparatus;
calling a collection company that will collect reusable or disposable containers loaded in the container recovery apparatus on the basis of the recovery information; and
updating recycling history of the reusable or disposable container on the basis of a result of product inspection on the reusable or disposable container collected through the collection company.

2. The method according to claim 1, further comprising the step of receiving stock information including the CUID from a store terminal when the reusable or disposable container including the CUID is stocked in the store.

3. The method according to claim 2, wherein the step of receiving stock information including the CUID includes the step of updating the recycling history of the reusable or disposable container on the basis of the stock information.

4. The method according to claim 1, wherein the step of receiving recovery information including the CUID includes the steps of:
calculating a recovery reward corresponding to the reusable or disposable container on the basis of the CUID; and
transmitting reward information to the container recovery apparatus on the basis of the calculated recovery reward.

5. The method according to claim 1, wherein the step of receiving recovery information including the CUID includes the steps of:
calculating a recovery reward corresponding to the reusable or disposable container on the basis of the CUID; and
transmitting reward information to the container recovery apparatus on the basis of the calculated recovery reward.

6. The method according to claim 5, wherein the recovery reward is calculated differently according to a reward accumulation means.

7. The method according to claim 5, wherein the step of receiving recovery information including the CUID further includes the step of paying the recovery reward according to a reward accumulation means selected by a user.

8. The method according to claim 1, wherein the step of receiving recovery information including the CUID further includes the step of updating the recycling history of the reusable or disposable container on the basis of the recovery information.

9. The method according to claim 1, wherein the step of calling a collection company includes the steps of:
determining a container loading state of the container recovery apparatus on the basis of the recovery information; and
calling a collection company to collect reusable or disposable containers loaded in the container recovery apparatus when the container loading state satisfies a first condition.

10. The method according to claim 9, wherein the collection company is determined on the basis of a priority calculated according to a distance between the container recovery apparatus and the collection company and a service fee of the collection company.

11. The method according to claim 10, wherein the priority is determined on the basis of a calculation formula that calculates a weighted sum of the distance and the service fee, wherein in the calculation formula, a first weight applied to the distance or a second weight applied to the service fee is determined differently when the container loading state is the first condition and a second condition.

12. The method according to claim 9, wherein the step of calling a collection company further includes the step of granting a right to access the container recovery apparatus to the collection company.

13. The method according to claim 1, wherein the recovery information includes identification information of a container box provided in the container recovery apparatus, and the CUID of the reusable or disposable container is mapped to the identification information of the container box.

14. The method according to claim 13, wherein the recycling history of the reusable or disposable container is updated in connection with the management history of the container box.

15. A system for managing reusable or disposable containers, the system comprising:
a processor;
a memory that loads a computer program executed by the processor; and
a storage for storing the computer program, wherein
the computer program includes instructions for executing
an operation of generating and providing a CUID,
an operation of receiving recovery information including the CUID from a container recovery apparatus when a reusable or disposable container including the CUID is recovered in the container recovery apparatus,
an operation of calling a collection company that will collect reusable or disposable containers loaded in the container recovery apparatus on the basis of the recovery information, and
an operation of updating recycling history of the reusable or disposable container on the basis of a result of product inspection on the reusable or disposable container collected through the collection company.
